(19) United States
(12) Patent Application Publication
(10) Pub. No.: US 2009/0021889 A1
(43) Pub. Date: Jan. 22, 2009

(54) INSULATOR FILM, CAPACITOR ELEMENT, DRAM AND SEMICONDUCTOR DEVICE

(75) Inventor: Masami Tanioku, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Elpida Memory, Inc, Tokyo (JP)

(21) Appl. No.: 12/056,990

(22) Filed: Mar. 27, 2008

(30) Foreign Application Priority Data
Jul. 20, 2007 (JP) P2007-189659

(51) Int. Cl. H01G 4/10

(52) U.S. Cl. 361/321.5; 361/322; 252/62.3 E

(57) ABSTRACT

The insulator film of the present invention is suited for use as the insulator material of capacitor elements composing DRAM, is used as the insulator layer of a capacitor element provided with an insulator layer that is interposed between an upper electrode and a lower electrode, and is composed of titanium dioxide to which at least one element from among the lanthanoid elements, Hf and Y is added.

### BACKGROUND OF THE INVENTION

1. Field of the Invention

The present invention relates to an insulator film, a capacitor element, a DRAM (Dynamic Random Access Memory), and a semiconductor device, and particularly to an insulator film used as the insulator layer of capacitor elements configuring the memory cells of the DRAM.

Priority is claimed on Japanese Patent Application No. 2007-189659 filed on Jul. 20, 2007, the content of which is incorporated herein by reference.

2. Description of Related Art

Conventionally, as insulator material of capacitor elements which are provided in the DRAM memory cells configuring semiconductor devices, Ta₂O₅, Al₂O₃, HfO₂, and their laminar films or the like have been used. The relative dielectric constant is on the order of 9 to 30. However, in order to advance further with miniaturization, materials with higher relative dielectric constants are required.

As materials with a high relative dielectric constant used as insulator material of capacitor elements, one may cite materials having perovskite crystal structure such as SrTiO₃ and BaSrTiO₃ (BST), which have relative dielectric constants of 100 or more. With respect to these perovskite crystal films which are capable of being expressed as ABO₃ type, studies of attribute control have conventionally been conducted by substituting the A-site and B-site ions of crystals to develop insulator material for use in capacitor elements.

As material with a high relative dielectric constant studied as insulator material for capacitor elements, titanium dioxide (TiO₂), which has a relative dielectric constant of 80, has been cited.

As insulator material for use in capacitor elements, amorphous (non-crystalline) PbTiO3 is disclosed in Japanese Unexamined Patent Application, First Publication (JP-A) No. S62-7147. As this insulator material, a perovskite titanium oxide compound expressed by the general formula of MTiO₃ (in the formula, M is one or more metallic elements selected from among Ba, Ca, Mg, Sr, Nb, Bi, Cd, Ce, and La) is disclosed in Japanese Unexamined Patent Application, First Publication (JP-A) No. H05-195227.

Moreover, as insulator material used in semiconductor devices, Japanese Unexamined Patent Application, First Publication (JP-A) No. 2003-309118 shows a multi-layer structure containing multiple laminated base layers wherein two layers with an alloy of titanium dioxide (TiO₂) and tantalum pentoxide (Ta₂O₅) base is included in the aforementioned layers, and separated by an intermediate layer composed of an alloy of hafnium dioxide (HfO₂) and alumina (Al₂O₃) base. Furthermore, as this insulator material, Japanese Unexamined Patent Application, First Publication (JP-A) No. 2003-303514 shows a multi-layer structure provided with multiple individual layers with respective thicknesses of less than 500 Å, wherein some of the aforementioned layers are made of aluminum, hafnium and oxygen base. Furthermore, as this insulator material, a high-dielectric-constant thin film is disclosed in Japanese Unexamined Patent Application, First Publication No. H08-45925 which is composed of a thin film whose principal component is strontium titanate (SrTiO₃) which has a surface layer whose principal component is SR₁₋ₓTiO₃ (provided that 0≦x≦1).

However, in the film formation stage of perovskite crystal film, there is the problem that crystal grain boundaries are inevitably produced, and that surface roughness increases. Consequently, this leads to deterioration in capacitance properties in the case where perovskite crystal film is used as insulator material of capacitor elements configuring a DRAM. Moreover, if perovskite crystal film is not crystallized, its performance cannot be realized. Accordingly, in order to form capacitor elements with the desired properties using perovskite crystal film, a sophisticated manufacturing technology for perovskite crystal film is required. However, with conventional technology, it has been difficult to control crystal grain boundaries and to form perovskite crystal film which has excellent surface roughness. Consequently, although development of perovskite crystal film has been conducted many times in the past, it has yet to be practically applied on a mass-production level as insulator material in semiconductor devices.

In addition, there is the problem that high breakdown voltage is required for insulator material used as the insulator material of capacitor elements configuring DRAM, and that TiO₂ and perovskite crystal films such as SrTiO₃ have low breakdown voltage due to narrow band gaps. The band gaps of TiO₂ and SrTiO₃ are only approximately 3 eV, rendering it difficult to form capacitor elements having practical breakdown voltage.

With respect to all of the conventional insulator materials, it has been impossible to easily vary the relative dielectric constant and breakdown voltage according to the electric properties of a DRAM which have capacitor elements. Consequently, there is the problem that it has heretofore been necessary to develop new insulator material when changing the requirements of the relative dielectric constant and breakdown voltage pertaining to insulator material in conjunction with miniaturization or the like, and that this demands time and labor.

Moreover, none of the conventional insulator materials have comprehensively satisfied a sufficiently large relative dielectric constant, a sufficiently high breakdown voltage, and ease of manufacture when used as insulator material of capacitor elements configuring a DRAM.

### SUMMARY OF THE INVENTION

The present invention was made in light of these circumstances, and its object is to provide an insulator film which enables easy variation of the relative dielectric constant and breakdown voltage, which has a sufficiently high relative dielectric constant and breakdown voltage, and which can be easily manufactured when used as insulator material of capacitor elements configuring a DRAM.

A further object is to provide a capacitor element, a DRAM and semiconductor device which are provided with the insulator film of the present invention.

The inventors of the present invention achieve the present invention as a result of diligent study for the purpose of solving the aforementioned problems. That is, the present invention pertains to the following matters.

The insulator film of the present invention is insulator film used as an insulator layer in a capacitor element which provides an insulator layer that is interposed between two electrodes, and is insulator film composed of titanium dioxide (TiO₂) to which at least one element from among the lanthanoid elements, Hf (hafnium) and Y (yttrium) is added.

Here, “lanthanoid elements” signify elements from La (Lanthan) with an atomic number of 57 to Lu (Lutetium) with an atomic number of 71.

In addition, the insulator film of the present invention is an insulator film which is interposed between opposing electrodes of a capacitor element, which is insulator film containing titanium and at least one element from among the lanthanoid elements, Hf and Y, and having a band gap width of 3 eV or higher in terms of energy level.

The insulator film of the present invention may be in a state where it is not completely crystallized (i.e., the insulator film may be in an amorphous state).

A capacitor element of the present invention is provided with an insulator layer that is interposed between two electrodes, wherein the aforementioned insulator layer is composed of the insulator film of the present invention.

A DRAM of the present invention is provided with a memory cell unit and peripheral circuit, wherein the aforementioned memory cell unit is provided with the capacitor element of the present invention.

A semiconductor device of the present invention is provided with the capacitor element of the present invention.

As the insulator film of the present invention includes titanium dioxide to which at least one element from among the lanthanoid elements, Hf and Y is added, and as any one of the lanthanoid elements, Hf or Y is added which are oxide metal elements that have a large band gap and a high relative dielectric constant relative to titanium dioxide (TiO₂), it has a sufficiently high relative dielectric constant and breakdown voltage when used as insulator material for capacitor elements configuring a DRAM.

Moreover, as the insulator film of the present invention is composed of titanium dioxide to which at least one element from among the lanthanoid elements, Hf and Y is added, and as it obtains a sufficiently high relative dielectric constant and breakdown voltage even without crystallization as with perovskite crystal film, manufacture is easy. That is, even when using only manufacturing devices which are commonly employed in semiconductor manufacture, it is possible to manufacture film which suppresses surface roughness, and to do so with quite excellent mass productivity.

Moreover, as the insulator film of the present invention is composed of titanium dioxide to which at least one element from among the lanthanoid elements, Hf and Y is added, it is possible to vary the relative dielectric constant and breakdown voltage by varying the element concentration of any one of the lanthanoid elements, Hf and Y in the titanium dioxide. Thus, according to the insulator film of the present invention, it is possible to easily offer insulator film which has an optimal relative dielectric constant and breakdown voltage according to the electric properties of the DRAM which have capacitor elements.

### BRIEF DESCRIPTION OF THE DRAWINGS

FIG. 1 is a sectional view in the parallel direction of a bit wiring layer to show a portion of the sectional structure according to one embodiment of the semiconductor device of the present invention.

FIG. 2 is a sectional view which shows the laminar structure of a specimen according to one embodiment of the semiconductor device of the present invention.

FIG. 3 is a graph which shows the results of X-ray diffraction (XRD) according to one embodiment of the semiconductor device of the present invention.

FIG. 4 is a graph which shows the relation of the La additive amount and the relative dielectric constant and breakdown voltage of an insulator film in one embodiment of the semiconductor device of the present invention.

FIG. 5 is a graph which shows the relation of the La additive amount and the energy level (eV) of conduction band edge or valence band edge relative to Pt electrode's Fermi level in one embodiment of the semiconductor device of the present invention.

FIG. 6 is a graph which shows the results of X-ray diffraction (XRD) in one embodiment of the semiconductor device of the present invention.

FIG. 7A is a graph which shows the relation of the Hf additive amount and the relative dielectric constant of an insulator film in one embodiment of the semiconductor device of the present invention.

FIG. 7B is a graph which shows the relation of Hf additive amount and breakdown voltage in one embodiment of the semiconductor device of the present invention.

### PREFERRED EMBODIMENTS OF THE INVENTION

A semiconductor device according to an embodiment of the present invention is explained with reference to drawings. With respect to the drawings used in the following description, there are areas where the dimensional proportions of the respective components have been changed in order to facilitate description, and the dimensional proportions of the respective components are not necessarily the same as in reality. Moreover, the materials enumerated in the following description are examples—the present invention is not necessarily limited by these, and may be appropriately modified and implemented within a scope which does change its essential elements.

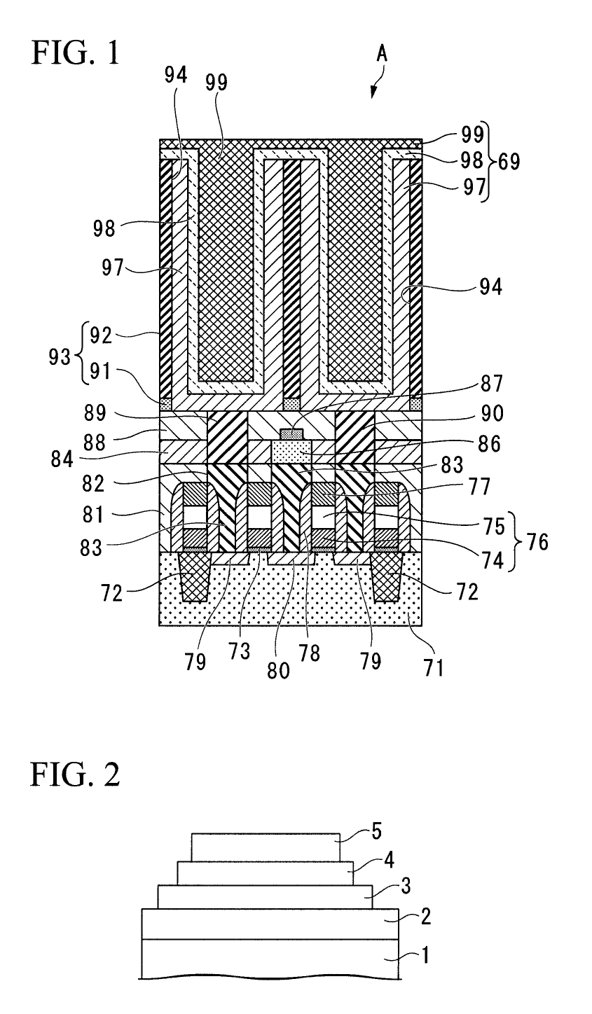

FIG. 1 is a drawing which serves to describe a portion of sectional structure according to one example of a semiconductor device of the present invention, and is a sectional view in a direction parallel to the bit wiring layer.

A semiconductor device A shown in FIG. 1 has a DRAM provided with a memory cell unit and peripheral circuit. The DRAM which configures the semiconductor device A shown in FIG. 1 is largely configured from a memory cell unit and peripheral circuit which are provided atop a semiconductor substrate 71. In FIG. 1, only the memory cell unit is illustrated in an enlarged manner, and depiction of the peripheral circuit is omitted. In the memory cell unit, a plurality of memory cells are provided in alignment which are respectively composed of a selection transistor and a capacitor element 69 that is connected to a source drain of the selection transistor via a contact plug and that is used as a storage capacitor. At the same time, the peripheral circuit is positioned around the memory cell unit, and multiple peripheral-circuit transistors are provided in alignment in the peripheral circuit.

In the semiconductor device A shown in FIG. 1, the semiconductor substrate 71 is composed of a semiconductor which contains impurities such as silicon in a specified concentration. In the portion other than the transistor formation region on the surface of the semiconductor substrate 71, element isolation regions 72 are formed by the STI (Shallow Trench Isolation) method to insulate and isolate the selection transistors.

In the transistor formation region, gate insulating film 73 is formed as silicon oxide film by thermal oxidation or the like on the surface of the semiconductor substrate 71. Gate electrodes 76 are composed of multi-layer film of a polycrystalline silicon film 74 and metallic film 75. As the polycrystalline silicon film 74, one may use doped polycrystalline silicon film which is formed by causing incorporation of impurities such as phosphorous during film formation by the CVD method. As the metallic film 75, one may use high-melting-point metal such as tungsten (W) or tungsten silicide (WSi).

On top of the gate electrode 76 (that is, on top of the metallic film 75), insulating film 77 composed of silicon nitride (Si3N4) or the like is formed, and side walls 78 composed of insulating film such as silicon nitride are formed on the side walls of the gate electrodes 76.

In the present embodiment, an example is shown of a cell structure wherein a 2-bit memory cell is arranged in one active region encompassed by the insulation-and-isolation regions 72. As shown in FIG. 1, in the single active region encompassed by the insulation-and-isolation regions 72, an impurity dispersion layer is arranged which is composed of sources 79 and a drain 80 at the two ends and at the center of the active region. In the present embodiment, a drain 80 is formed in the impurity dispersion layer at the center of the active region, sources 79, 79 are formed in the impurity dispersion layer at the two ends of the active region, the gate insulating films 73 are formed on top of the sources 79 and drain 80 so as to contact these, and the gate electrodes 76 are formed on top of the gate insulating films 73 to form the basic structure of the selection transistor.

A first interlayer insulating film 81 is formed over the entire surface on top of the semiconductor substrate 71 and insulating film 77. The first interlayer insulating film 81 is composed from laminar film of BPSG film and TEOS—NSG film. In the first interlayer insulating film 81, multiple cell contact holes 82 are provided by means of perforation so as to expose the sources 79 and drain 80. The cell contact holes 82 are filled with polycrystalline silicon film of a prescribed impurity concentration, whereby cell contact plugs 83 are formed.

A second interlayer insulating film 84 is formed over the entire surface on top of the first interlayer insulating film 81 and cell contact plugs 83. The second interlayer insulating film 84 is composed of a silicon oxide film. In the second interlayer insulating film 84, multiple bit contact holes are provided by means of perforation so as to expose the end faces of the cell contact plugs 83. The interior of these bit contact holes are filled with conductive material, whereby bit contact plugs 86 are formed. On the surface of the bit contact plugs 86, bit wiring layers 87 are formed which are composed of a metallic film such as tungsten film. The bit wiring layers 87 are connected to the drain 80 via the bit contact plugs 86 and the underlying cell contact plugs 83.

A third interlayer insulating film 88 is formed over the entire surface on top of the second interlayer insulating film 84 and bit wiring layers 87. The third interlayer insulating film 88 is composed of a silicon oxide film by the plasma CVD method. In the third interlayer insulating film 88 and second interlayer insulating film 84, capacitor contact holes 89 are provided by means of perforation so as to expose the end faces of the cell contact plugs 83. The interior of these capacitor contact holes 89 are filled with polycrystalline silicon film of a prescribed impurity concentration, whereby capacitor contact plugs (contact plugs) 90 are formed.

A fourth interlayer insulating film 93 is formed on top of the third interlayer insulating film 88 and capacitor contact plugs 90. The fourth interlayer insulating film 93 is composed of a nitride film 91 and a silicon oxide film 92 constituting the cylinder core. At positions where the surface of the fourth interlayer insulating film 93 and capacitor contact plugs 90 are exposed, capacitor deep-hole cylinders 94 are provided by perforating the fourth interlayer insulating film 93.

A lower electrode 97 is provided on the bottom face and inner circumferential face of the capacitor deep-hole cylinder 94. A capacitance insulating film 98 (insulator film) is formed on the fourth interlayer insulating film 93 and on the surface of the lower electrode 97, and an upper electrode 99 is formed on top of the capacitance insulating film 98 formed on the fourth interlayer insulting film 93 and inside the cylinder encompassed by the capacitance insulating film 98. That is, the capacitor element 69 which constitutes the storage capacitor for data storage is formed by the lower electrode 97, upper electrode 99 and capacitance insulating film 98 interposed between the lower electrode 97 and upper electrode 99.

As the lower electrode 97 and upper electrode 99, conductive film such as polysilicon or titanium nitride film is used. It is possible to use other electrode material according to the material of the employed capacitance insulating film 98.

As the capacitance insulating film 98, an insulator film is used which is composed of titanium dioxide to which is added any one element from among lanthanoid elements, Hf or Y, which are oxide metal elements which have a large band gap and a high relative dielectric constant relative to titanium dioxide (TiO₂). The insulator film composing the capacitance insulating film 98 of the present invention is able to satisfy the required electrical properties in the capacitor even in an uncrystallized, amorphous state.

The relative dielectric constant and breakdown voltage of the insulator film is varied according to the concentration of whichever one of the aforementioned elements is added to the titanium dioxide composing the insulator film. The relative dielectric constant of the insulator film varies within a range from 25 to 80, and increases as the element concentration is lowered. The breakdown voltage of the insulator film is higher than that of the titanium dioxide (TiO₂), and increases as the element concentration is raised.

In the present embodiment, as the element added to titanium dioxide, it is sufficient to have at least one element from among the lanthanoid elements, Hf and Y, and while there is no problem in terms of film properties even if two or more are added, it is preferable to add only one of them when mass productivity in the manufacturing process is taken into consideration.

For example, in the case where La is added to titanium dioxide, an insulator film is obtained which is balanced in terms of both the breakdown voltage and relative dielectric constant of the capacitor element by setting the La additive rate (La/(La+Ti)) to 10%-50%.

As another example, in the case where Hf is added to titanium dioxide, an insulator film is obtained which is balanced in terms of both the breakdown voltage and relative dielectric constant of the capacitor element by setting the Hf additive rate (Hf/(Hf+Ti)) to 10%-65%.

Even when Y or a lanthanoid element other than La is used as the additive element, it is sufficient to add the element in an appropriate amount relative to the titanium dioxide so as to obtain the desired capacitor properties.

With respect to the insulator film of the present invention, it is possible to obtain better properties for capacitor-element insulating film than can be obtained with insulating film composed only of titanium dioxide. Accordingly, in the case where, for example, Hf is selected as the additive element, its additive amount is not limited to within the aforementioned 10%-65%, and it may be added at less than 10% or more than 65%.

The insulator film composing the capacitance insulating film 98 of the present embodiment may be formed by the sputtering method, ordinary CVD (chemical vapor deposition) method, ALD (atomic layer deposition) method and the like using common semiconductor manufacturing equipment.

For example, a description is given of the case where, as the capacitance insulating film 98, an insulator film composed of titanium dioxide to which La has been added is formed by the sputtering method on the formed substrate (subject formation face) of the various members up to the lower electrode 97. First, a TiO₂ target and a LaTiO target composed of a sintered compact of LaTiO (La: Ti=1:1) are arranged inside a chamber. Next, while rotating the subject formation face arranged at a position opposite the respective targets, RF (high frequency) power is respectively supplied to each target and discharged. By this means, an insulator film composed of titanium dioxide to which La has been added is formed on the subject formation face.

In the case where an insulator film composed of titanium dioxide to which La has been added is formed by the aforementioned method, the additive amount of La in the titanium dioxide is made proportionate to the supply quantity of raw material constituting the insulator film from the respective targets to the subject formation face. Accordingly, by controlling the supply quantity of the raw material constituting the insulator film from the respective targets to the subject formation face, it is possible to form titanium dioxide films with differing La additive amounts.

The supply quantity of raw material constituting the insulator film from the respective targets to the subject formation face is made proportionate to the RF power which is supplied to the respective targets. Accordingly, in the case where a TiO₂ target and a LaTiO target composed of a sintered compact of LaTiO (La: Ti=1:1) are used as the targets, it is possible to form titanium dioxide films wherein the La additive amount (La/La+Ti) differs in a prescribed range by a method which varies the RF power supplied to the respective targets.

Moreover, the supply quantity of raw material constituting the insulator film from the targets to the subject formation face can also be varied by a method which varies the La content of the targets. Accordingly, it is also possible to vary the La additive amount in titanium dioxide to which La is added by varying the La content of the employed targets when the insulator film is formed.

Furthermore, it is also acceptable to control the La additive amount in titanium dioxide to which La is added by combining the method which controls the RF power supplied to the targets and the method which varies the La content of the targets, and controlling the supply quantity of raw material constituting the insulator film from the respective targets to the subject formation face.

It is also acceptable to control the La additive amount in the same way using targets formed from material containing La other than LaTiO.

In the present embodiment, a description was given of an example of a formation method pertaining to insulator film composed of titanium dioxide to which La is added, but even in the case where one forms insulator film composed of titanium dioxide to which—instead of La—any element from among lanthanoid elements other than La, Hf and Y is added, it is possible to control the additive amount of the aforementioned element in the titanium dioxide by the method which varies the RF power supplied to the targets and/or the method which varies the content of the additive element contained in the targets.

In the case where insulator film composing the capacitance insulating film 98 is formed by the sputtering method, it is preferable to conduct post-annealing (heat treatment) of 1 to 10 minutes at a temperature of 500° C. to 700° C. in an oxygen atmosphere after formation of the insulator film. In the case where the insulator film is formed at a low temperature on the order of 300° C., ordinarily, it happens that film defects occur, oxidation of the insulator film is insufficient, and the leak properties of the insulator film are impaired. By conducting post-annealing treatment, it is possible to improve the film defects deriving from the low-temperature formation of insulator film, and to further improve leak properties. The temperature and time of post-annealing may be determined according to the insulator film formation method and the leak properties required with respect to the insulator film.

For example, when forming the insulator film by the sputtering method, the occurrence of film defects during insulator film formation can be suppressed in the case where sophisticated sputtering technology employing oxidizing agents or the like is used, in the case where the insulator film is formed by a film formation method such as the CVD method, etc., with the result that post-annealing may be omitted.

That is, in the insulator film formation method of the present invention, post-annealing is not an indispensable process, and one may decide whether or not to conduct post-annealing according to the properties ultimately to be obtained and applied to semiconductor devices such as DRAM. Moreover, in the case where post-annealing is conducted, conditions such as temperature and time may be varied according to the properties of the desired insulator film.

The semiconductor device A of the present embodiment uses insulator film composed of titanium dioxide to which at least one element from among the lanthanoid elements, Hf and Y is added as the capacitance insulating film 98 of capacitor elements 69 configuring DRAM, with the result that a capacitance insulating film 98 is provided which has a sufficiently high relative dielectric constant and breakdown voltage.

As the capacitance insulating film 98 is composed of titanium dioxide to which at least one element from among the lanthanoid elements, Hf and Y is added, it is possible to easily form a capacitance insulating film 98 composed of uniform, dense and flat film using common semiconductor manufacturing equipment.

Moreover, the capacitance insulating film 98 of the present embodiment does not need to be crystallized like perovskite crystal film, and the desired capacitor properties are obtainable in an amorphous state. Accordingly, when used in an amorphous state, the problem of surface roughness stemming from crystallization does not occur.

For example, in the case where the capacitance insulating film 98 is a crystal film, the capacitance insulating film 98 is affected by the crystallinity of the material composing the lower electrode 97 which is formed under the capacitance insulating film 98, with the result that the quality of the capacitance insulating film 98 is strongly dependent on the material and film quality of the lower electrode 97, which constitutes a major limitation and difficulty from the standpoint of practical application. However, as the capacitance insulating film 98 of the present embodiment is in an amorphous state, it is possible to offer uniform quality without relation to the quality of the lower electrode 97. Consequently, formation of the lower electrode 97 and capacitance insulating film 98 is facilitated. Moreover, options pertaining to the material and formation method of the lower electrode 97 can be increased.

With the capacitance insulating film 98 of the present embodiment, it is possible to vary the relative dielectric constant and breakdown voltage by varying the concentration of whichever element from among the lanthanoid elements, Hf and Y is contained in the titanium dioxide. Accordingly, it is possible to easily offer capacitance insulating film 98 having the desired relative dielectric constant and breakdown voltage according to the electrical properties of DRAM which have capacitor elements 69.

As the semiconductor device A of the present embodiment is provided with capacitance insulating film 98 which has a sufficiently high relative dielectric constant and breakdown voltage as the capacitor element 69, it has high-performance DRAM.

In the present embodiment, as one example of the insulator film of the present invention, a description was given of the case of capacitance insulating film 98 of capacitor elements 69 composing DRAM, but the insulator film of the present invention is not limited to this case alone. For example, there are no particular limitations on the form of the conductor film, and it may have a flat shape, or it may be formed on the outer wall parts of a cylindrical electrode.

Furthermore, the insulator film of the present invention can be applied without problem to DRAM memory cells and to eDRAM which form common logic products on the same semiconductor chip.

Moreover, it is possible to apply the present invention to semiconductor devices other than semiconductor devices provided with DRAM, if they have capacitor elements which are provided with an insulator layer interposed between an upper electrode and a lower electrode.

### EXPERIMENTAL EXAMPLE 1

A specimen composed of the laminar structure shown in FIG. 2 was manufactured as described below, and the experiments described below were conducted.

In FIG. 2, code number 1 indicates an Si substrate, code number 2 a thermal oxide film composed of SiO₂, code number 3 a lower electrode composed of Pt film, code number 4 an insulator film, and code number 5 an upper electrode composed of Pt (platinum) film.

In order to obtain the laminar structure shown in FIG. 2, first, the Si substrate 1 is prepared on the top face of which is formed the thermal oxide film 2 composed of SiO₂ used for interdiffusion prevention. Next, a lower electrode 3 is formed on top of the thermal oxide film 2 of the Si substrate 1 by forming Pt film with a film thickness of 100 nm by the sputtering method.

Subsequently, the insulator film 4 composed of titanium dioxide was formed on top of the lower electrode 3 by the sputtering method. Formation of the insulator film 4 was conducted by arranging a TiO₂ target inside the chamber, and by supplying 150 W of RF (high-frequency) power to the TiO₂ target and causing discharge while rotating the Si substrate 1 which was arranged at a position opposite the target, with the temperature of the Si substrate 1 formed up to the lower electrode 3 set to 300° C., and the chamber pressure set to 0.5 Pa with simultaneous circulation of Ar and O₂ gases.

As a result, the insulator film 4 composed of titanium dioxide film (a) was obtained.

Next, the upper electrode 5 was formed by forming Pt film with a film thickness of 30 nm by the sputtering method on top of the Si substrate 1 formed up to the insulator film 4.

Thereafter, thermal treatment was conducted for 3 minutes at a temperature of 700° C. in an oxygen atmosphere as post-annealing. In this manner, the laminar structure shown in FIG. 2 was obtained which has insulator film 4 composed of titanium dioxide film (a) wherein the La additive amount (La/(La+Ti)) is 0%.

Next, as shown below, the laminar structure shown in FIG. 2 was obtained which has an insulator film 4 composed of titanium dioxide films (b)-(g) with differing La additive amounts (La/(La+Ti)) in the range of 9-50%.

That is, in the same manner as the laminar structure having insulator film 4 composed of titanium dioxide film (a) with an La additive amount (La/(La+Ti)) of 0%, insulator film 4 composed of titanium dioxide to which La was added at a prescribed concentration was formed by the sputtering method on top of the lower electrode 3, atop the Si substrate 1 formed up to the lower electrode 3. Formation of the insulator films 4 was conducted by arranging a TiO₂ target and LaTiO target composed of a sintered compact of LaTiO (La: Ti=1:1) inside the chamber, and by supplying the RF (high-frequency) power shown in Table 1 to the TiO₂ target and LaTiO target and causing discharge while rotating the Si substrate 1 which was arranged at a position opposite the respective targets, with the temperature of the Si substrate 1 formed up to the lower electrode 3 set to 300° C., and the chamber pressure set to 0.5 Pa with simultaneous circulation of Ar and O₂ gases. As a result, insulator films 4 composed of titanium dioxide films (b)-(g) with different La additive amounts (La/(La+Ti)) were obtained.

TABLE 1

| | |
|---|---|
| RF power (W) | La concentration (%) |

| LaTiO | TiO₂ | ICP | RBS |
|---|---|---|---|
| 10 | 150 | 9 | 9 |
| 20 | 150 | 19 | 18 |
| 50 | 150 | 31 | 31 |
| 50 | 100 | 35 | 35 |
| 50 | 50 | 42 | 41 |
| 50 | 0 | 51 | 50 |

Next, in the same manner as the laminar structure having the insulator film 4 composed of titanium dioxide film (a) on top of the Si substrate formed up to the insulator film 4, the upper electrode 5 was formed, and post-annealing was conducted.

With regard to the respective laminar structures of FIG. 2 having insulator films 4 composed of titanium dioxide films (b)-(g) with different La additive amounts obtained in this manner, the La additive amount was investigated using the inductively-coupled plasma mass spectrometry (ICP-MS) method and the Rutherford backscattering spectroscopy (RBS) method. The results are shown in Table 1.

From Table 1, it was able to be confirmed that the La additive amount in titanium dioxide film to which La has been added can be controlled by varying the RF power supplied to the TiO₂ target and LiTiO target.

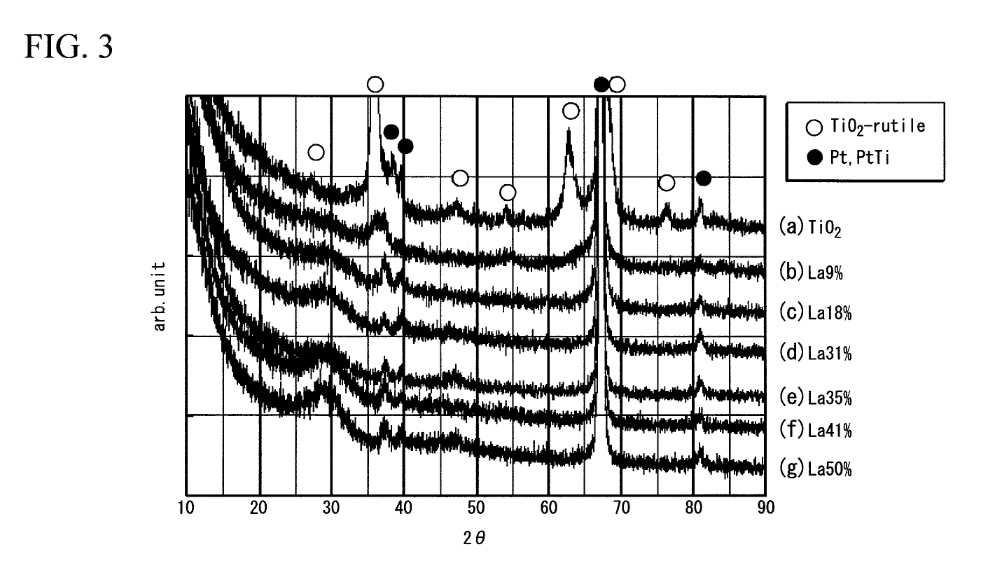

Next, X-ray diffraction (XRD) was conducted by inplane measurement (low-angle incidence) with respect to the laminar structure having the insulator film 4 composed of titanium dioxide film (a) wherein the La additive amount is 0% and the respective laminar structures having insulator films 4 composed of titanium dioxide films (b)-(g) with different La additive amounts. The results are shown in FIG. 3.

As shown in FIG. 3, the peak of the Si substrate 1 does not appear due to inplane measurement (low-angle incidence). From the peaks at positions shown by the white circles in FIG. 3, it is clear that the titanium dioxide film (a) has undergone crystallization, and that a rutile structure (a stable crystal structure in the TiO₂ crystal) has formed. It is clear that a slight amount of TiO₂ crystal has formed with the titanium dioxide film (b) wherein the La additive amount is 9%.

However, from titanium dioxide film (c) with La additive amount of 18% to titanium dioxide film (g) with La additive amount of 50%, no peaks relating to TiO₂ crystallization are observed, and nothing is observed other than the peaks at positions shown by black circles in FIG. 3 relating to the Pt film composing the lower electrode 3 and upper electrode 5. In addition, from titanium dioxide film (c) with La additive amount of 18% to titanium dioxide film (g) with La additive amount of 50%, a broad peak can be observed at a position where 20 is slightly less than 30°. The position of these peaks is the location where the crystal of LaTi oxide (during random sloping) shows its maximum peak, and the fact that these peaks are broad peaks indicates that the titanium dioxide films (c)-(g) to which La is added are typical amorphous films.

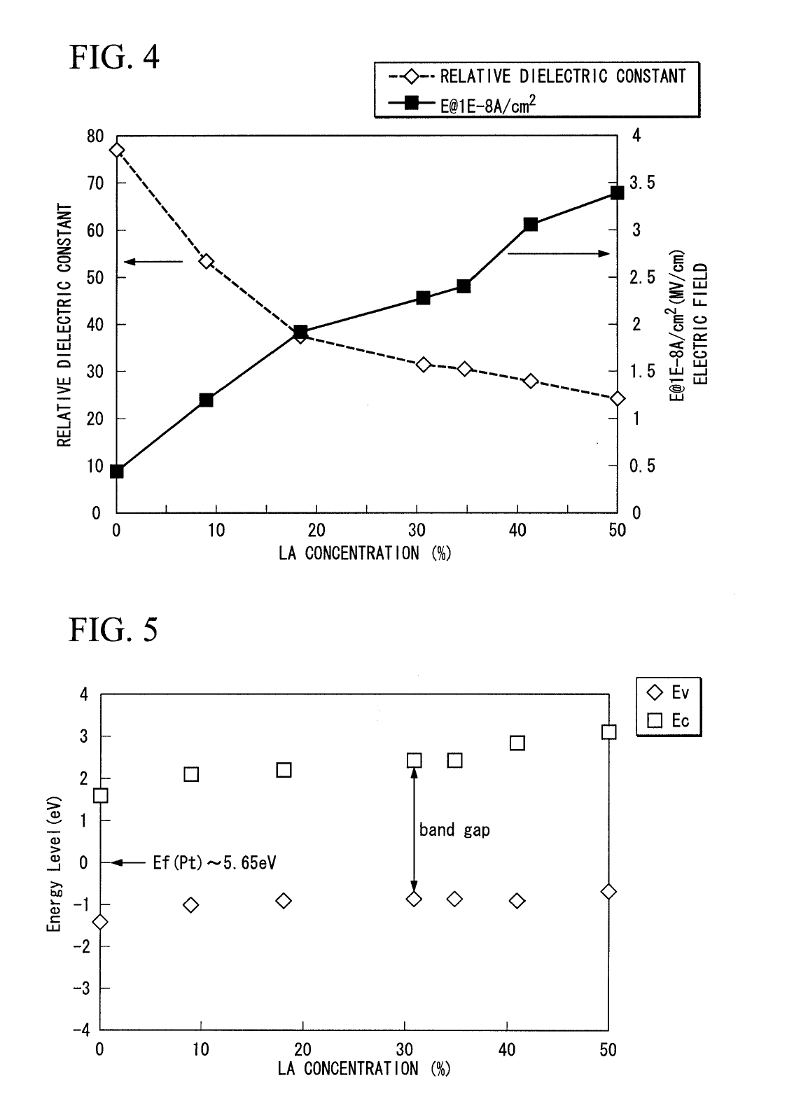

With respect to the laminar structure having the insulator film 4 composed of titanium dioxide film (a) wherein the La additive amount is 0% and the respective laminar structures having the insulator films 4 composed of titanium dioxide films (b)-(g) with different La additive amounts, the relative dielectric constant and breakdown voltage (electric field when leak current density reaches 1E-8A/cm²) were measured. The results are shown in FIG. 4.

FIG. 4 is a graph that shows the relation of the La additive amount to the relative dielectric constant and breakdown voltage of the insulator film 4. As shown in FIG. 4, it was able to be confirmed that the relative dielectric constant increases as the La additive amount decreases, and that breakdown voltage increases as the La additive amount increases.

As stated above, partial crystallization occurs in the titanium dioxide film (b) wherein the La additive amount is 9%, and a higher breakdown voltage is obtained than in titanium dioxide film (a) wherein the La additive amount is 0%. Accordingly, the insulator film of the present invention is not necessarily limited to use in a completely amorphous state.

In addition, the band gap and the band offset relative to the lower electrode 3 and upper electrode 5 were investigated with respect to the laminar structure having the insulator film 4 composed of titanium dioxide film (a) wherein the La additive amount is 0% and the respective laminar structures having the insulator films 4 composed of titanium dioxide films (b)-(g) with different La additive amounts. The results are shown in FIG. 5.

FIG. 5 is a graph which shows the relation of the La additive amount and the energy level (eV) of the conduction band edge or the valence band edge relative to the Pt electrode's Fermi level.

In FIG. 5, the band offset is energy barrier height relative to Pt Fermi level. FIG. 5 shows energy barrier (Ec) of the conduction band edge in the insulating film relative to the Fermi level (Ef) of Pt as a reference (0 eV). Also, FIG. 5 shows energy barrier (Ev) of the valence band edge relative to the Fermi level (Ef) of Pt as a reference (0 eV). The band gap is represented by Ec-Ev.

As shown in FIG. 5, relative to the band gap of 3 eV of titanium dioxide film (a) wherein the La additive amount is 0%, the band gaps with titanium dioxide films (b)-(g) to which La is added are higher at 3.1 eV to 3.8 eV.

As shown in FIG. 5, the band offsets (Ec) between the Pt Fermi level (Ef) and the conduction band edge of the insulator film 4 are 2.1 eV to 3.1 eV with titanium dioxide films (b)-(g) to which La is added. These are higher than the 1.6 eV of titanium dioxide film (a), thereby proving that there is improvement of breakdown voltage.

### EXPERIMENTAL EXAMPLE 2

Specimens with the laminar structure shown in FIG. 2 were manufactured as described below and subjected to the experiments described below in the same manner as Experimental Example 1, except that the insulator film 4 composing the laminar structure shown in FIG. 2 was an insulator film composed of HfO₂ or an insulator film composed of titanium dioxide to which Hf was added.

That is, as in Experimental Example 1, an insulator film 4 composed of HfO2 was formed on top of the lower electrode 3 by the sputtering method, on top of the Si substrate 1 formed up to the lower electrode 3. Formation of the insulator film 4 was conducted by arranging a HfO₂ target inside the chamber, and by supplying 50 W of RF (high-frequency) power to the HfO₂ target and causing discharge while rotating the Si substrate 1 which was arranged at a position opposite the target, with the temperature of the Si substrate 1 formed up to the lower electrode 3 set to 300° C., and the chamber pressure set to 0.5 Pa with simultaneous circulation of Ar and O₂ gases.

Next, as in Experimental Example 1, an upper electrode was formed on top of the Si substrate 1 formed up to the insulator film 4, and post-annealing was conducted, whereby the laminar structure shown in FIG. 2 was obtained with an insulator film 4 composed of HfO₂ film.

Next, as shown below, the laminar structure shown in FIG. 2 was obtained with insulator films 4 composed of titanium dioxide wherein the Hf additive amount (Hf/Hf+Ti)) was made to differ in a range from 8 to 78%.

That is, in the same manner as Experimental Example 1, insulator film 4 composed of titanium dioxide to which Hf was added at a prescribed concentration was formed by the sputtering method on top of the lower electrode 3, atop the Si substrate 1 formed up to the lower electrode 3. Formation of the insulator films 4 was conducted by arranging a TiO₂ target and HfO₂ target inside the chamber, and by supplying the RF (high-frequency) power shown in Table 2 to the TiO₂ target and HfO₂ target and causing discharge while rotating the Si substrate 1 which was arranged at a position opposite the respective targets, with the temperature of the Si substrate 1 formed up to the lower electrode 3 set to 300° C., and the chamber pressure set to 0.5 Pa with simultaneous circulation of Ar and O₂ gases. As a result, insulator films 4 composed of titanium dioxide films with different Hf additive amounts (Hf/(Hf+Ti)) were obtained.

TABLE 2

| | |
|---|---|
| RF power (W) | Hf concentration (%) |

| HfO₂ | TiO₂ | RBS |
|---|---|---|
| 10 | 150 | 8 |
| 18 | 150 | 20 |
| 23 | 150 | 27 |
| 32 | 150 | 37 |
| 39 | 150 | 43 |
| 50 | 127 | 53 |
| 50 | 43 | 78 |

Next, in the same manner as Experimental Example 1, the upper electrode 5 was formed on top of the Si substrate formed up to the insulator film 4, and post-annealing was conducted, whereby the laminar structure shown in FIG. 2 was obtained which had insulator films 4 composed of titanium dioxide film with differing Hf additive amounts (Hf/(Hf+Ti)).

With regard to the respective laminar structures of FIG. 2 having insulator films 4 composed of titanium dioxide films with different Hf additive amounts obtained in this manner, the Hf additive amount was investigated using the Rutherford backscattering spectroscopy (RBS) method. The results are shown in Table 2.

From Table 2, it was able to be confirmed that the Hf additive amount in titanium dioxide film to which Hf has been added can be controlled by varying the RF power supplied to the TiO₂ target and HfO₂ target.

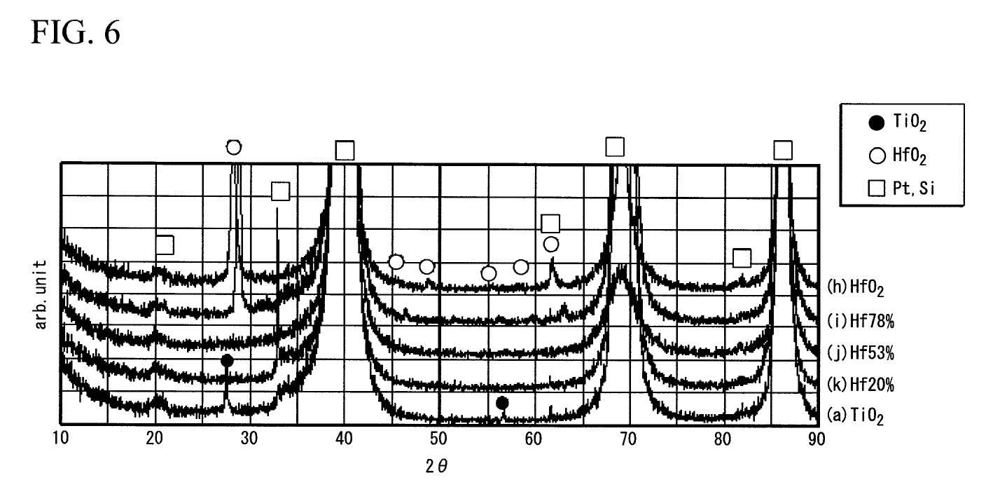

Next, X-ray diffraction (XRD) was conducted with respect to the laminar structure having the insulator film 4 composed of titanium dioxide film (a) wherein the Hf additive amount is 0% and the respective laminar structures having insulator films 4 composed of titanium dioxide films (i)-(k) with different Hf additive amounts. The results are shown in FIG. 6.

From the peaks at positions shown by the black circles in FIG. 6, it is clear that the titanium dioxide film (a) has undergone crystallization, and that a rutile structure (a stable crystal structure in the TiO₂ crystal) has formed.

Crystal peaks of monoclinic structure shown by the white circles in FIG. 6 were observed with respect to HfO₂ film (h) and titanium dioxide film (i) with an Hf additive amount of 78%. Moreover, as titanium dioxide film (i) with an Hf additive amount of 78% is HfO₂ crystal wherein Ti of small ionic diameter has partially undergone site substitution, the peaks shown by white circles in FIG. 6 are produced at the same position as HfO₂ and skewed (with a small lattice constant) toward the high-angle side.

However, with respect to titanium dioxide film (j) with an Hf additive amount of 53% and titanium dioxide film (k) of 20%, nothing was observed other than the peaks at positions shown by the white squares in FIG. 6 which relate to the Pt film composing the lower electrode 3 and upper electrode 5 and the Si composing the Si substrate 1, and it is clear that crystallization has not occurred (it is amorphous film).

### EXPERIMENTAL EXAMPLE 3

Specimens with the laminar structure shown in FIG. 2 having insulator films 4 composed of titanium dioxide film with differing Hf additive content (Hf/(Hf+Ti)) ranging from 8% to 78% were manufactured in the same manner as Experimental Example 2, except that the post-annealing temperature was set to 500° C. or 600° C., and the experiments described below were conducted.

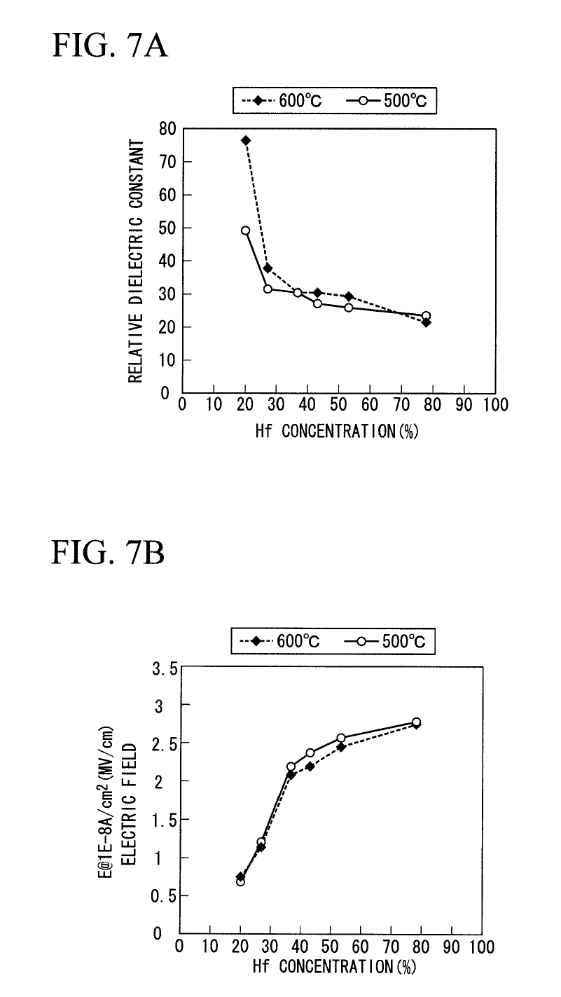

That is, laminar structures were formed having insulator films 4 composed of titanium dioxide film whose Hf additive amount was 8%, 20%, 27%, 37%, 43%, 53% and 78%. With respect to each of these, the relative dielectric constant and breakdown voltage (electric field when leak current density reaches 1E-8A/cm²) were measured. The results are shown in FIG. 7.

FIG. 7A is a graph that shows the relation of the Hf additive amount (Hf/(Hf+Ti)) in titanium dioxide film and the relative dielectric constant. As shown in FIG. 7A, it is clear that there is little difference between the case where the post-annealing temperature is 500° C. and the case where it is 600° C., and that post-annealing may be conducted even at the lower temperature of 500° C.

FIG. 7B is a graph that shows the relation of the Hf additive amount (Hf/(Hf+Ti)) in titanium dioxide film and breakdown voltage. As shown in FIG. 7B, it is clear that there is little difference between the case where the post-annealing temperature is 500° C. and the case where it is 600° C., and that post-annealing may be conducted even at the lower temperature of 500° C.

As shown in FIG. 7A and FIG. 7B, it is possible to make the values of the dielectric constant and breakdown voltage of insulator film variable according to the concentration at which the Hf is added. Accordingly, it is sufficient to set the concentration of the Hf which is added and the post-annealing temperature according to the electrical properties required by the capacitor formed using the insulator film of the present invention.

As described above, with respect to capacitor elements using the insulator film of the present invention, it is possible to enlarge the band gap width and improve breakdown voltage compared to films composed of titanium dioxide by adding at least one element from among the lanthanoid elements, Hf and Y to titanium dioxide. Furthermore, the insulator film of the present invention has optimal properties as insulator film for use in capacitors even in a state where it is not crystallized. Accordingly, it is possible to avoid the manufacturing problems which derive from crystallization and to easily form high-performance capacitor elements.

What is claimed is:

1. An insulator film used as an insulator layer interposed between two electrodes in a capacitor element, the insulator film comprising titanium dioxide to which at least one element from among the lanthanoid elements, Hf and Y is added.

2. An insulator film interposed between opposing electrodes of a capacitor element, the insulator film comprising titanium and at least one element from among the lanthanoid elements, Hf and Y, and having a band gap width of 3 eV or higher in terms of energy level.

3. The insulator film according to claim 1, wherein the insulator film is not completely crystallized.

4. The insulator film according to claim 2, wherein the insulator film is not completely crystallized.

5. A capacitor element comprising:
two electrodes, and
an insulator layer interposed between said two electrodes, and comprising titanium dioxide containing at least one element from among the lanthanoid elements, Hf and Y.

6. A capacitor element comprising:
two electrodes, and
an insulator layer interposed between said two electrodes, and comprising titanium and at least one element from among the lanthanoid elements, Hf and Y and having a band gap width of 3 eV or higher in terms of energy level.

7. A DRAM comprising:
a memory cell unit provided with a capacitor element including two electrodes, and an insulator layer interposed between said two electrodes and comprising titanium dioxide containing at least one element from among the lanthanoid elements, Hf and Y; and
a peripheral circuit disposed around said memory cell unit.

8. A DRAM comprising:
a memory cell unit provided with a capacitor element including two electrodes, and an insulator layer interposed between said two electrodes and comprising titanium and at least one element from among the lanthanoid elements, Hf and Y and having a band gap width of 3 eV or higher in terms of energy level; and
a peripheral circuit disposed around said memory cell unit.

9. A semiconductor device provided with a capacitor element including two electrodes, and an insulator layer interposed between said two electrodes and comprising titanium dioxide containing at least one element from among the lanthanoid elements, Hf and Y.

10. A semiconductor device provided with a capacitor element including two electrodes, and an insulator layer interposed between said two electrodes and comprising titanium and at least one element from among the lanthanoid elements, Hf and Y and having a band gap width of 3 eV or higher in terms of energy level.
